(19) United States
(12) Patent Application Publication
(10) Pub. No.: US 2026/0158867 A1
(43) Pub. Date: Jun. 11, 2026

(54) HEAT PUMP SYSTEM FOR A VEHICLE

(71) Applicants: HYUNDAI MOTOR COMPANY, Seoul (KR); KIA CORPORATION, Seoul (KR)

(72) Inventors: Jeawan Kim, Hwaseong-si (KR); Hochan An, Hwaseong-si (KR); Yeon Ho Kim, Hwaseong-si (KR); Hoyoung Jeong, Hwaseong-si (KR); Man Hee Park, Hwaseong-si (KR); Yeong Jun Kim, Hwaseong-si (KR); Jae Yeon Kim, Hwaseong-si (KR); Gwi Taek Kim, Hwaseong-si (KR)

(73) Assignees: HYUNDAI MOTOR COMPANY, Seoul (KR); KIA CORPORATION, Seoul (KR)

(21) Appl. No.: 19/205,512

(22) Filed: May 12, 2025

(30) Foreign Application Priority Data
Dec. 6, 2024 (KR) 10-2024-0181007

(51) Int. Cl. B60H 1/32; B60H 1/00

(52) U.S. Cl. CPC B60H 1/3204; B60H 1/00278; B60H 1/00335

(57) ABSTRACT

A heat pump system for a vehicle capable of improving cooling and heating performance by applying a gas injection device selectively operating in an air conditioning mode of the vehicle interior to increase the flow rate of the refrigerant is disclosed. The heat pump system includes a compressor, a condenser, a first expansion valve, an evaporator, a first connection line, a chiller, a second expansion valve, a sub-heat-exchanger, and a gas injection device, wherein, depending on at least one mode for adjusting a temperature of a vehicle interior, the flow rate of the refrigerant is controlled through an operation control of the gas injection device.

### CROSS-REFERENCE TO RELATED APPLICATION

This application claims priority to and the benefit of Korean Patent Application No. 10-2024-0181007 filed with the Korean Intellectual Property Office on Dec. 6, 2024, the entire contents of which is incorporated herein by reference.

### BACKGROUND

### Technical Field

The present disclosure relates to a heat pump system for a vehicle, and more particularly, the present disclosure relates to a heat pump system for a vehicle capable of improving the cooling and heating performance by employing a gas injection device configured to selectively operate in a selected air conditioning mode.

### Description of the Related Art

Generally, an air conditioning system for a vehicle includes an air conditioner unit circulating a refrigerant in order to heat or cool an interior of a vehicle.

The air conditioner unit, which maintains the interior of the vehicle at an appropriate temperature regardless of a change in an external temperature to maintain a comfortable interior environment, is configured to heat or cool the interior of the vehicle by heat-exchange by a condenser and an evaporator in a process in which a refrigerant discharged by driving of a compressor is circulated back to the compressor through the condenser, a receiver drier, an expansion valve, and the evaporator.

In other words, the air conditioner unit lowers a temperature and a humidity of the interior by condensing a high-temperature high-pressure gas-phase refrigerant compressed from the compressor by the condenser, passing the refrigerant through the receiver drier and the expansion valve, and then evaporating the refrigerant in the evaporator in a cooling mode in the summer.

In accordance with a continuous increase in interest in energy efficiency and an environmental pollution problem, the development of an environment-friendly vehicle capable of substantially substituting for an internal combustion engine vehicle is required, and the environment-friendly vehicle is classified into an electric vehicle driven using a fuel cell or electricity as a power source and a hybrid vehicle driven using an engine and a battery.

In an electric vehicle or a hybrid vehicle among these environment-friendly vehicles, a separate heater is not used unlike an air conditioner of a general vehicle, and an air conditioner used in an environment-friendly vehicle is generally called a heat pump system.

An electric vehicle driven by the power source of the fuel cell generates driving force by converting chemical reaction energy between oxygen and hydrogen into electrical energy. In this process, heat energy is generated by a chemical reaction in a fuel cell. Therefore, it is necessary in securing performance of the fuel cell to effectively remove generated heat.

In addition, a hybrid vehicle generates driving force by driving a motor using electricity supplied from the fuel cell described above or an electrical battery, together with an engine operated by a general fuel, such as gasoline. Therefore, heat generated from the fuel cell or the battery and the motor should be effectively removed in order to secure performance of the motor.

Therefore, in a hybrid vehicle or an electric vehicle according to the related art, a cooling means, a heat pump system, and a battery cooling system, respectively, should be configured as separate closed circuits so as to prevent heat generation of the motor, an electric component, and the battery including a fuel cell.

Therefore, a size and a weight of a cooling module disposed at the front of the vehicle are increased, and a layout of connection pipes supplying a refrigerant and a coolant to each of the heat pump system, the cooling means, and the battery cooling system in an engine compartment becomes complicated.

In addition, since a battery cooling system for heating or cooling the battery according to a state of the vehicle is separately provided to obtain an optimal performance of the battery, a plurality of valves for selectively interconnecting connections pipes are employed, and thus noise and vibration due to frequent opening and closing operations of the valves may be introduced into the vehicle interior, thereby deteriorating the ride comfort of the vehicle.

In addition, for heating the vehicle interior, the heating performance may be deteriorated due to the lack of a heat source, the electricity consumption may be increased due to the usage of the electric heater, and the power consumption of the compressor may be increased.

The above information disclosed in this Background section is only for enhancement of understanding of the background of the disclosure, and therefore it may contain information that does not form the prior art that is already known in this country to those having ordinary skill in the art.

### SUMMARY

The present disclosure attempts to provide a heat pump system for a vehicle capable of improving cooling and heating performance by applying a gas injection device selectively operating in an air conditioning mode of the vehicle interior to increase the flow rate of the refrigerant.

A heat pump system for a vehicle includes a compressor configured to compress a refrigerant. The heat pump system further includes a condenser connected to the compressor through a refrigerant line, and configured to condense the refrigerant. The heat pump system further includes a first expansion valve connected to the condenser through the refrigerant line. The heat pump system further includes an evaporator connected to the first expansion valve through the refrigerant line, connected to the compressor through the refrigerant line, and configured to evaporate the supplied refrigerant. The heat pump system further includes a first connection line having a first end connected to the refrigerant line between the condenser and the first expansion valve, and a second end connected to the refrigerant line between the compressor and the evaporator. The heat pump system further includes a chiller provided on the first connection line, and configured to adjust a temperature of a coolant by heat-exchanging the refrigerant introduced through the first connection line with a selectively introduced coolant. The heat pump system further includes a second expansion valve provided on the first connection line at an upstream end of the chiller. The heat pump system further includes a sub-heat-exchanger provided on the refrigerant line between the condenser and the first expansion valve, and configured to condense or evaporate the selectively introduced refrigerant. The heat pump system further includes a gas injection device provided on the refrigerant line between the sub-heat-exchanger and the first expansion valve, configured to selectively expand the refrigerant supplied from one of the condenser or the sub-heat-exchanger and allow the expanded refrigerant to flow, and selectively supply a partial refrigerant among the supplied refrigerant to the compressor, to increase a flow rate of the refrigerant circulating the refrigerant line, where, based on at least one mode of the heat pump system for adjusting a temperature of a vehicle interior, the flow rate of the refrigerant is controlled through an operation control of the gas injection device.

The gas injection device may include a heat-exchanger provided on the refrigerant line between the sub-heat-exchanger and the first expansion valve. The gas injection device may further include a first line having a first end connected to the refrigerant line between the sub-heat-exchanger and the heat-exchanger, and a second end connected to the heat-exchanger. The gas injection device may further include a third expansion valve provided on the first line at an upstream end of the heat-exchanger, a second line having a first end connected to the heat-exchanger, and a second end connected to the compressor. The gas injection device may further include a fourth expansion valve provided on the refrigerant line between the condenser and the sub-heat-exchanger. The gas injection device may further include a third line having a first end connected to the fourth expansion valve, and a second end connected to the first line. The gas injection device may further include a fourth line having a first end connected to the fourth expansion valve, and a second end connected to the refrigerant line between the heat-exchanger and the first expansion valve.

The heat-exchanger may be operated when the expanded refrigerant is supplied through the first line, and configured to supply a gaseous refrigerant among the supplied refrigerant to the compressor through the second line, to increase the flow rate of the refrigerant circulating the refrigerant line.

When an operation of the gas injection device is required, the third expansion valve may expand the refrigerant supplied from at least one of the condenser or the sub-heat-exchanger through the first line, and may supply the expanded refrigerant to the heat-exchanger.

The heat pump system may further include a second connection line having a first end connected to the refrigerant line between the condenser and the fourth expansion valve, and a second end connected to the refrigerant line between the sub-heat-exchanger and the heat-exchanger. The heat pump system may further include a control valve provided on the second connection line, and configured to selectively open and close the second connection line. The heat pump system may further include a third connection line having a first end connected to the refrigerant line between the sub-heat-exchanger and the heat-exchanger. The heat pump system may further include a fifth expansion valve connected to a second end of the third connection line.

The heat pump system may include a fourth connection line having a first end connected to the fifth expansion valve, and a second end connected to the refrigerant line between the evaporator and the compressor. The heat pump system may further include a fifth connection line having a first end connected to the refrigerant line between the compressor and the condenser, and a second end connected to the fifth expansion valve.

The at least one mode may include: a first mode for cooling the vehicle interior and in which the gas injection device is operated; a second mode for recollecting a waste heat of an electrical component and a waste heat of a battery module while heating the vehicle interior and in which the gas injection device is operated; a third mode for recollecting an ambient air heat, the waste heat of the electrical component, and the waste heat of the battery module while heating the vehicle interior and in which the gas injection device is operated; and a fourth mode for heating the vehicle interior by using the refrigerant without recollecting heat and in which the gas injection device is not operated.

In the first mode, the refrigerant line connecting the compressor, the condenser, the sub-heat-exchanger, the first expansion valve, and the evaporator may be opened. The first line may be opened by the third expansion valve. The second line may be opened. The third line and the fourth line may be closed by the fourth expansion valve. The second connection line may be closed by a control valve. The third connection line, the fourth connection line, and the fifth connection line may be closed by the fifth expansion valve. The first expansion valve may expand the refrigerant introduced through the refrigerant line and may supply the expanded refrigerant to the evaporator. The third expansion valve may expand the refrigerant introduced through the first line, and may supply the expanded refrigerant to the heat-exchanger through the first line. The fourth expansion valve may allow the refrigerant introduced from the condenser to flow to the sub-heat-exchanger without expansion. The fifth expansion valve may stop operating. The heat-exchanger may supply a gaseous refrigerant among the interiorly introduced refrigerant to the compressor through the opened second line.

When cooling of the battery module is required in the first mode, the first connection line may be opened by the second expansion valve, and the second expansion valve may expand the refrigerant introduced through the first connection line and may supply the expanded refrigerant to the chiller.

In the second mode, a portion of the refrigerant line interconnecting the compressor, the condenser, and the fourth expansion valve may be opened by the fourth expansion valve. A portion of the refrigerant line connecting the first end of the first connection line and the heat-exchanger and a portion of the refrigerant line connecting the second end of the first connection line and the compressor may be opened. A portion of the refrigerant line connecting the second end of the second connection line and the heat-exchanger may be opened. A portion of the refrigerant line connecting the first end of the first connection line to the first expansion valve and the evaporator, and the refrigerant line connecting the evaporator to the second end of the first connection line may be closed. The first connection line may be opened by the second expansion valve. A portion of the first line connecting the first end of the first line to the second end of the third line may be closed. A remaining first line connecting the second end of the third line to the heat-exchanger may be opened by the third expansion valve. The second line may be opened. The third line may be opened by the fourth expansion valve. The second connection line may be opened by a control valve. The third connection line, the fourth connection line, and the fifth connection line may be closed by a fifth expansion valve. The first expansion valve and the fifth expansion valve stop operating. The second expansion valve may expand the refrigerant introduced through the first connection line and may supply the expanded refrigerant to the chiller. The third expansion valve may expand the refrigerant introduced through the first line, and may supply the expanded refrigerant to the heat-exchanger through the first line. The fourth expansion valve may allow the refrigerant introduced through the refrigerant line to flow to the third line without expansion. The heat-exchanger may supply the gaseous refrigerant among the refrigerant to the compressor through the opened second line.

In the third mode, a portion of the refrigerant line connecting the compressor, the condenser, and the fourth expansion valve may be opened by the fourth expansion valve. A portion of the refrigerant line connecting the fourth expansion valve to the first end of the third connection line may be opened by the fourth expansion valve and a fifth expansion valve. A portion of the refrigerant line connecting the first end of the first connection line and the heat-exchanger and a portion of the refrigerant line connecting the second end of the first connection line and the compressor may be opened. A portion of the refrigerant line connecting the second end of the second connection line and the heat-exchanger may be opened. A portion of the refrigerant line connecting the first end of the first connection line to the second end of the fourth line may be opened. A portion of the refrigerant line connecting the second end of the fourth line to the first expansion valve and the evaporator, and the refrigerant line connecting the evaporator to the second end of the first connection line may be closed. The first connection line may be opened by the second expansion valve. A portion of the first line connecting the first end of the first line to the second end of the third line may be closed. A remaining first line connecting the second end of the third line to the heat-exchanger may be opened by the third expansion valve. the second line may be opened. The third line may be opened by the fourth expansion valve. The fourth line may be opened by the fourth expansion valve. The second connection line may be opened by a control valve. The third connection line and the fourth connection line may be opened by the fifth expansion valve. The fifth connection line may be closed by the fifth expansion valve. the first expansion valve may stop operating. The second expansion valve may expand the refrigerant introduced through the first connection line and may supply the expanded refrigerant to the chiller. The third expansion valve may expand the refrigerant introduced through the first line, and may supply the expanded refrigerant to the heat-exchanger through the first line. The fourth expansion valve may allow the refrigerant introduced from the condenser to flow to the fourth expansion valve in the third line without expansion. The fourth expansion valve may expand the refrigerant introduced through the fourth line, and may supply the expanded refrigerant to the sub-heat-exchanger through the refrigerant line. The fifth expansion valve may allow the refrigerant introduced through the third connection line to flow to the fourth connection line without expansion. The heat-exchanger may supply the gaseous refrigerant among the refrigerant to the compressor through the opened second line.

In the fourth mode, a portion of the refrigerant line connecting the compressor to the first end of the second connection line through the condenser may be opened. A portion of the refrigerant line connecting the first end of the second connection line to the second end of the second connection line through the fourth expansion valve and the sub-heat-exchanger may be closed by the fourth expansion valve. A portion of the refrigerant line connecting the heat-exchanger and the first end of the first connection line, and a portion of the refrigerant line connecting the second end of the first connection line and the compressor may be opened. A portion of the refrigerant line connecting the first end of the first connection line to the second end of the first connection line through the first expansion valve and the evaporator may be closed by the first expansion valve. The portion of the refrigerant line connecting the second end of the second connection line and the heat-exchanger may be opened. The first connection line may be opened by the second expansion valve. The first line may be closed by the third expansion valve. The second line may be closed. The third line and the fourth line may be closed by the fourth expansion valve. The second connection line may be opened by the control valve. The third connection line may be closed by the fifth expansion valve. The fourth connection line and the fifth connection line may be opened by the fifth expansion valve. The first expansion valve, the third expansion valve, and the fourth expansion valve may stop operating. The second expansion valve may expand the refrigerant introduced through the first connection line and may supply the expanded refrigerant to the chiller. The fifth expansion valve may expand the refrigerant introduced through the fifth connection line from the compressor, and may allow the expanded refrigerant to flow along the fourth connection line.

The fifth expansion valve may be a 3-way electronic expansion valve configured to selectively expand the refrigerant while controlling the flow rate of the supplied refrigerant.

The first expansion valve, the second expansion valve, and the third expansion valve may be 2-way electronic expansion valves configured to selectively expand the refrigerant while controlling a flow rate of the supplied refrigerant. The fourth expansion valve may be a 4-way electronic expansion valve configured to selectively expand the refrigerant while controlling the flow rate of the supplied refrigerant.

The heat pump system may further include an electrical component and a battery module in which the coolant circulates, and a heating device in which the coolant circulates so as to heat the vehicle interior by using a high-temperature coolant.

The chiller may be connected to the electrical component through a first coolant line circulating the coolant, and connected to the battery module through a second coolant line circulating the coolant.

When a waste heat of the electrical component is to be recollected at a time of heating the vehicle interior, the first coolant line may be opened to connect the chiller and the electrical component.

When the battery module is to be cooled while cooling the vehicle interior, or when a waste heat of the battery module is to be recollected at a time of heating the vehicle interior, the second coolant line may be opened to connect the chiller and the battery module.

The condenser may be connected to the heating device through a third coolant line circulating the coolant.

When heating the vehicle interior, the third coolant line may be opened to connect the condenser and the heating device.

As described above, according to a heat pump system for a vehicle according to an embodiment of the present disclosure, cooling and heating performance may be improved by applying a gas injection device selectively operating in an air conditioning mode of the vehicle interior to increase the flow rate of the refrigerant.

In addition, according to the present disclosure, the performance of the system by using the gas injection device may be maximized while minimizing the required components, and accordingly, streamlining and simplification of the system may be achieved.

In addition, according to the present disclosure, by selectively using ambient air heat, the waste heat of the electrical component, or the waste heat of the battery module when heating the vehicle interior, the heating efficiency may be improved.

In addition, according to the present disclosure, even when the external temperature is low and the heat generated from the electrical components and the battery module is not sufficient in an early state of driving the vehicle, heating of the vehicle interior may be efficiently performed.

In addition, according to the present disclosure, through streamlining of an entire system, it is possible to reduce manufacturing cost and weight and improve space utilization of a vehicle or a system for the vehicle.

### BRIEF DESCRIPTION OF THE DRAWINGS

FIG. 1 is a block diagram of a heat pump system for a vehicle according to an embodiment.

FIG. 2 is an operation diagram according to a first mode of a heat pump system for a vehicle according to an embodiment.

FIG. 3 is an operation diagram according to a second mode of a heat pump system for a vehicle according to an embodiment.

FIG. 4 is an operation diagram according to a third mode of a heat pump system for a vehicle according to an embodiment.

FIG. 5 is an operation diagram according to a fourth mode of a heat pump system for a vehicle according to an embodiment.

### DETAILED DESCRIPTION

Embodiments of the present disclosure are hereinafter described in detail with reference to the accompanying drawings.

Embodiments disclosed in the present specification and the constructions depicted in the drawings are only example embodiments of the present disclosure, and do not cover the entire scope of the present disclosure. Therefore, it should be understood that there may be various equivalents to and variations of the disclosed embodiments at a time that the technical concepts of this specification are applied.

In order to clarify the present disclosure, parts that are not related to the description may have been omitted. Further, the same elements or equivalents are referred to with the same reference numerals throughout the specification.

Also, the size and thickness of each element may be arbitrarily shown in the drawings, but the present disclosure is not necessarily limited thereto. In the drawings, the thickness of layers, films, panels, regions, and the like, may be exaggerated for clarity.

In addition, unless explicitly described to the contrary, the words “comprise”, “have”, “include” and variations thereof such as “comprises” or “comprising”, should be understood to imply the inclusion of stated elements but not the exclusion of any other elements.

Furthermore, each of terms, such as “. . . unit”, “. . . means”, “. . . portions”, “. . . part”, and “. . . member” described in the specification, mean a unit of a comprehensive element that performs at least one function or operation. When a component, device, unit, module, controller, detector, element, or the like of the present disclosure is described as having a purpose or performing an operation, function, or the like, the component, device, unit, module, controller, detector, or element should be considered herein as being “configured to” meet that purpose or to perform that operation or function. The present disclosure describes a controller and a data detector for a cooling system. The controller, detector, or other such components may separately embody or be included with a processor and a memory, such as a non-transitory computer readable media, as part of the controller or component.

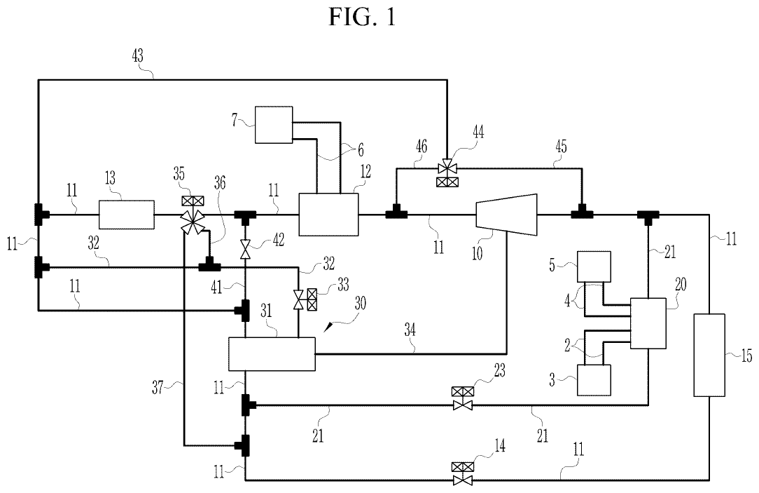

FIG. 1 is a block diagram of a heat pump system for a vehicle according to an embodiment of the present disclosure.

According to a heat pump system for a vehicle according to an embodiment of the present disclosure, by employing a gas injection device 30 selectively operating in at least one selected mode for adjusting a temperature of a vehicle interior to increase a flow rate of a refrigerant, the cooling and heating performance of the system may be improved.

Referring to FIG. 1, the heat pump system may include an electrical component 3 and a battery module 5 in which a coolant circulates, and a heating device 7 in which the coolant circulates to heat the vehicle interior by using a high-temperature coolant.

Such a heat pump system may further include a compressor 10, a condenser 12, a sub-heat-exchanger 13, a first expansion valve 14, an evaporator 15, a chiller 20, a first connection line 21, a second expansion valve 23, and the gas injection device 30.

The electrical component 3 may be connected to the chiller 20 through a first coolant line 2 along or through which the coolant circulates. When a waste heat of the electrical component 3 is to be recollected at the time of heating the vehicle interior, the first coolant line 2 may be opened to connect the chiller 20 and the electrical component 3.

An embodiment of the present disclosure takes an example in which the electrical component 3 is connected through the first coolant line 2, but is not limited thereto, and the electrical component 3 may be connected to the condenser 12 through a separate coolant line.

Accordingly, at the time of cooling the vehicle interior, the electrical component 3 may supply the coolant to the condenser 12 through the separate coolant line, so that the condenser 12 may condense the refrigerant.

In an embodiment, the battery module 5 may be connected to the chiller 20 through a second coolant line 4 along or through which the coolant circulates.

When the battery module 5 is to be cooled while cooling the vehicle interior, or when the waste heat of the battery module 5 is to be recollected at the time of heating the vehicle interior, the second coolant line 4 may be opened to connect the chiller 20 and the battery module 5.

In addition, the heating device 7 may be connected to the condenser 12 through a third coolant line 6 along or through which the coolant circulates.

When heating the vehicle interior, the third coolant line 6 may be opened to connect the heating device 7 and the condenser 12, to supply the high-temperature coolant to the heating device 7.

Accordingly, the coolant whose temperature is increased through heat-exchange with the refrigerant in the condenser 12 may be supplied to the heating device 7 along the third coolant line 6.

The high-temperature coolant supplied to the heating device 7 may increase a temperature of ambient air passing through the heating device 7. In other words, the introduced ambient air may be converted into a high-temperature state while passing through the heating device 7 and then introduced into the vehicle interior, thereby implementing heating of the vehicle interior.

A water pump (not shown) may be provided on, i.e., connected to or along, each of the first coolant line 2, the second coolant line 4, and the third coolant line 6, and the coolant may be selectively circulated by an operation of each water pump to impart flow of the coolant through the coolant lines.

In an embodiment, the compressor 10 may compress the supplied refrigerant and allow the compressed refrigerant to flow along the refrigerant line 11 so that the refrigerant circulates along a refrigerant line 11.

The condenser 12 may be connected to the compressor 10 through the refrigerant line 11. The condenser 12 may condense the supplied refrigerant through heat-exchange with the coolant.

In other words, when heating the vehicle interior, the condenser 12 may condense the refrigerant supplied from the compressor 10 through heat-exchange with the coolant supplied from the heating device 7 through the third coolant line 6.

The condenser 12 may be a water-cooled heat-exchanger configured to heat-exchange the interiorly introduced refrigerant with the coolant.

The sub-heat-exchanger 13 may be provided on the refrigerant line 11 between the condenser 12 and the first expansion valve 14. The sub-heat-exchanger 13 may be disposed at an upstream end, i.e., the front of the vehicle (relative to the normal driving or movement direction).

Accordingly, in the at least one mode of the heat pump system, the sub-heat-exchanger 13 may condense or evaporate the introduced refrigerant through heat-exchange with the ambient air introduced during driving of the vehicle.

In other words, the sub-heat-exchanger 13 may be an air-cooled heat-exchanger configured to heat-exchange the introduced refrigerant with the ambient air.

In an embodiment, the first expansion valve 14 may be connected to the condenser 12 or the sub-heat-exchanger 13 through the refrigerant line 11. The first expansion valve 14 may selectively expand the introduced refrigerant.

The first expansion valve 14 may be a 2-way electronic expansion valve configured to selectively expand the refrigerant while controlling the flow of the supplied refrigerant.

The evaporator 15 may be connected to the first expansion valve 14 through the refrigerant line 11. In addition, the evaporator 15 may be connected to the compressor 10 through the refrigerant line 11. The evaporator 15 may evaporate the refrigerant supplied from the first expansion valve 14 through heat-exchange with the ambient air.

The evaporator 15 may be provided inside an HVAC module (not shown) together with the heating device 7.

Accordingly, the ambient air passing through the evaporator 15 may be cooled while passing through the evaporator 15 by a low-temperature refrigerant supplied to the evaporator 15. The cooled ambient air may be introduced into the vehicle interior, thereby cooling the vehicle interior.

Although not shown in the drawings, the heat pump system may further include an accumulator.

The accumulator may be provided on, i.e., connected to or along, the refrigerant line 11 between the evaporator 15 and the compressor 10. Such an accumulator may supply only the gaseous refrigerant (of the supplied refrigerant separated into a gaseous refrigerant and a liquid refrigerant) to the compressor 10, thereby improving the efficiency and durability of the compressor 10.

In an embodiment, the chiller 20 may adjust a temperature of the coolant selectively supplied through the first coolant line 2 and second coolant line 4 by heat-exchanging the supplied refrigerant with the coolant.

In other words, the chiller 20 may be a water-cooled heat-exchanger configured to heat-exchange the interiorly introduced refrigerant with the coolant.

The chiller 20 may be connected to the refrigerant line 11 through the first connection line 21.

A first end of the first connection line 21 may be connected to the refrigerant line 11 between the condenser 12 and the first expansion valve 14. In more detail, the first end of the first connection line 21 may be connected to the refrigerant line 11 between the sub-heat-exchanger 13 and the first expansion valve 14.

In addition, a second end of the first connection line 21 may be connected to the refrigerant line 11 between the evaporator 15 and the compressor 10.

The chiller 20 may adjust the temperature of the coolant by heat-exchanging the coolant selectively introduced through at least one of the first coolant line 2 or the second coolant line 4 with the refrigerant selectively supplied through the first connection line 21.

Accordingly, each coolant heat-exchanged with the refrigerant in the chiller 20 may be selectively supplied to the electrical component 3 or the battery module 5, to adjust the temperature of the electrical component 3 and the battery module 5.

The chiller 20 configured as such may be disposed in parallel with the evaporator 15 through the first connection line 21.

In an embodiment, the second expansion valve 23 may be provided on, i.e., connected to or along, the first connection line 21 at an upstream end of the chiller 20, based on the flow direction of the refrigerant.

When the battery module 5 is to be cooled by using the coolant heat-exchanged with the refrigerant while cooling the vehicle interior, the second expansion valve 23 may expand the refrigerant introduced through the first connection line 21 and allow the expanded refrigerant to flow into the chiller 20.

In other words, when the battery module 5 is to be cooled while cooling the vehicle interior, the second expansion valve 23 may expand the refrigerant introduced into the first connection line 21 to lower its temperature and allow the expanded refrigerant to flow into chiller 20, and thereby may further lower the temperature of the coolant passing through the interior of the chiller 20.

Accordingly, the coolant having its temperature decreased while passing through the chiller 20 may be introduced into the battery module 5, thereby achieving more efficient cooling.

To the contrary, when the waste heat generated from one of the electrical component 3 or the battery module 5 is to be recollected at the time of heating the vehicle interior, the second expansion valve 23 may expand the refrigerant introduced through the first connection line 21, and may supply the expanded refrigerant to the chiller 20.

Accordingly, the chiller 20 may evaporate the refrigerant through heat-exchange with the coolant supplied through at least one of the first coolant line 2 or the second coolant line 4.

The chiller 20 may recollect the waste heat of the electrical component 3 or the battery module 5 while heat-exchanging the refrigerant supplied from the second expansion valve 23 with the coolant supplied from the battery module 5.

The second expansion valve 23 configured as such may be a 2-way electronic expansion valve configured to selectively expand the refrigerant while controlling the flow of the supplied refrigerant.

The upstream end of the chiller 20 may be set based on the flow direction of the refrigerant. Based on the direction in which the refrigerant flows along the first connection line 21, the location where the refrigerant is introduced into the chiller 20 may be defined as an upstream end of the chiller 20, and the location where the refrigerant is discharged from the chiller 20 may be defined as a downstream end of the chiller 20.

In addition, the gas injection device 30 may be provided on the refrigerant line 11 between the sub-heat-exchanger 13 and the first expansion valve 14.

The gas injection device 30 may selectively expand the refrigerant supplied from one of the condenser 12 or the sub-heat-exchanger 13 and allow the expanded refrigerant to flow, and selectively supply a partial refrigerant among the supplied refrigerant to the compressor 10, so as to increase the flow rate of the refrigerant circulating the refrigerant line 11.

The gas injection device 30 configured as such may be selectively operated at the time of cooling or heating the vehicle interior.

The gas injection device 30 may include a heat-exchanger 31, a first line 32, a third expansion valve 33, a second line 34, a fourth expansion valve 35, a third line 36, and a fourth line 37.

The heat-exchanger 31 may be provided on the refrigerant line 11 between the sub-heat-exchanger 13 and the first expansion valve 14. The heat-exchanger 31 may be operated when the expanded refrigerant is supplied.

A first end of the first line 32 may be connected to the refrigerant line 11 between the sub-heat-exchanger 13 and the heat-exchanger 31. A second end of the first line 32 may be connected to the heat-exchanger 31.

In an embodiment, the third expansion valve 33 may be provided on, i.e., connected to or along, the first line 32 at an upstream end of the heat-exchanger 31, based on the flow direction of the refrigerant. The third expansion valve 33 may selectively expand the introduced refrigerant.

When an operation of the gas injection device 30 is required, the third expansion valve 33 may expand the refrigerant supplied from at least one of the condenser 12 or the sub-heat-exchanger 13 through the first line 32, and may supply the expanded refrigerant to the heat-exchanger 31.

The third expansion valve 33 configured as such may be a 2-way electronic expansion valve configured to selectively expand the refrigerant while controlling the flow of the refrigerant.

A first end of the second line 34 may be connected to the heat-exchanger 31. A second end of the second line 34 may be connected to the compressor 10.

When the expanded refrigerant is supplied to the heat-exchanger 31, the second line 34 may selectively supply the gaseous refrigerant from the heat-exchanger 31 to the compressor 10.

In other words, the second line 34 may connect the heat-exchanger 31 and the compressor 10 so that the gaseous refrigerant separated at the heat-exchanger 31 (i.e., separated into a gaseous refrigerant and a liquid refrigerant) is selectively introduced into the compressor 10.

In an embodiment, the fourth expansion valve 35 may be provided on, i.e., connected to or along, the refrigerant line 11 between the condenser 12 and the sub-heat-exchanger 13.

A first end of the third line 36 may be connected to the fourth expansion valve 35. A second end of the third line 36 may be connected to the first line 32 at an upstream end of the third expansion valve 33, based on the flow direction of the refrigerant.

In addition, a first end of the fourth line 37 may be connected to the fourth expansion valve 35. A second end of the fourth line 37 may be connected to the refrigerant line 11 between the heat-exchanger 31 and the first expansion valve 14.

In the at least one mode of the heat pump system, the third line 36 and the fourth line 37 configured as such may be selectively opened and closed by the fourth expansion valve 35.

The fourth expansion valve 35 may be a 4-way electronic expansion valve configured to selectively expand the refrigerant while controlling the flow of the supplied refrigerant.

In the gas injection device 30 configured as such, the heat-exchanger 31 may heat-exchange the refrigerant discharged from one of the condenser 12 or the sub-heat-exchanger 13, and the refrigerant expanded in the third expansion valve 33, with each other.

In addition, the gaseous refrigerant among the refrigerant heat-exchanged while passing through the heat-exchanger 31 may be supplied to the compressor 10 through the second line 34. In addition, the liquid refrigerant among the refrigerant heat-exchanged while passing through the heat-exchanger 31 may flow along the refrigerant line 11.

In other words, the heat-exchanger 31 may be operated when the expanded refrigerant is supplied through the first line 32. Accordingly, the heat-exchanger 31 may supply a gaseous refrigerant among the supplied refrigerant to the compressor 10 through the second line 34, to increase the flow rate of the refrigerant circulating along or through the refrigerant line 11.

The heat pump system configured as such may further include a second connection line 41, a control valve 42, a third connection line 43, a fifth expansion valve 44, a fourth connection line 45, and a fifth connection line 46.

A first end of the second connection line 41 may be connected to the refrigerant line 11 between the condenser 12 and the fourth expansion valve 35. A second end of the second connection line 41 may be connected to the refrigerant line 11 between the sub-heat-exchanger 13 and the heat-exchanger 31.

The control valve 42 may be provided on the second connection line 41. In the at least one mode of the heat pump system, the control valve 42 may selectively open and close the second connection line 41.

In an embodiment, a first end of the third connection line 43 may be connected to the refrigerant line 11 between the sub-heat-exchanger 13 and the heat-exchanger 31.

In more detail, the first end of the third connection line 43 may be connected to the refrigerant line 11 connecting the sub-heat-exchanger 13 and the first end of the first line 32.

The fifth expansion valve 44 may be connected to a second end of the third connection line 43.

In an embodiment, a first end of the fourth connection line 45 may be connected to the fifth expansion valve 44. A second end of the fourth connection line 45 may be connected to the refrigerant line 11 between the evaporator 15 and the compressor 10.

In more detail, the second end of the fourth connection line 45 may be connected to the refrigerant line 11 connecting the second end of the first connection line 21 and the compressor 10.

In addition, a first end of the fifth connection line 46 may be connected to the refrigerant line 11 between the compressor 10 and the condenser 12. A second end of the fifth connection line 46 may be connected to the fifth expansion valve 44.

The fifth expansion valve 44 may be a 3-way electronic expansion valve configured to selectively expand the refrigerant while controlling the flow of the supplied refrigerant.

When ambient air heat and the waste heat of the electrical component 3 or the battery module 5 are recollected together at the time of heating the vehicle interior, or when only the ambient air heat is recollected at the time of heating the vehicle interior, the fifth expansion valve 44 may open the third connection line 43 and the fourth connection line 45, and may close the fifth connection line 46.

To the contrary, when the waste heat of the electrical component 3 or the battery module 5 is recollected at the time of heating the vehicle interior, or when cooling the vehicle interior, the fifth expansion valve 44 may close the third connection line 43, the fourth connection line 45, and the fifth connection line 46.

In addition, at the time of hot gas heating for heating the vehicle interior by using the refrigerant without recollecting heat, the fifth expansion valve 44 may close the third connection line 43, and may open the fourth connection line 45 and the fifth connection line 46.

When heating of the vehicle interior is required while the external temperature is low and the heat generated from the electrical component 3 and the battery module 5 is not sufficient in an early state of driving the vehicle, the heat pump system may perform heating of the vehicle interior by directly using a high-pressure and high-temperature refrigerant.

As described above, heating the vehicle interior by using only the refrigerant may be referred to as hot gas heating.

In the heat pump system configured as such, the flow rate of the refrigerant may be controlled through an operation control of the gas injection device 30, depending on at least one mode for adjusting the temperature of the vehicle interior.

The at least one mode may include a first mode, a second mode, a third mode, and a fourth mode.

In the first mode, the gas injection device 30 may be operated, and the vehicle interior may be cooled.

In the second mode, the gas injection device 30 may be operated, and the electrical component 3 and the waste heat of the battery module 5 may be recollected while heating the vehicle interior.

In the third mode, the gas injection device 30 may be operated, and the ambient air heat, the waste heat of the electrical component 3, and the waste heat of the battery module 5 may be recollected while heating the vehicle interior.

In addition, in the fourth mode, the gas injection device 30 may not be operated, and the vehicle interior may be heated by using the refrigerant without recollecting heat.

The fourth mode may be a hot gas heating mode in which heating of the vehicle interior is performed by using only the refrigerant while other heat sources are not sufficient.

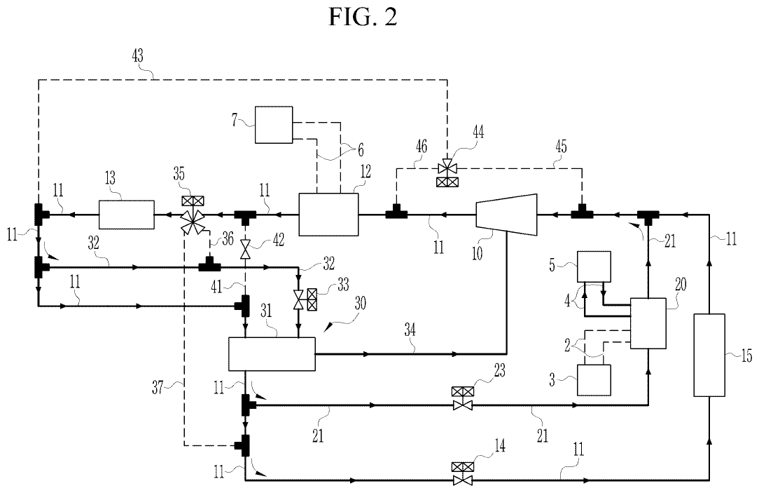

Hereinafter, an operation and action of a heat pump system for a vehicle according to an embodiment of the present disclosure configured as described above is described in detail with reference to FIGS. 2-5.

An operation in the first mode for cooling the vehicle interior and in which the gas injection device 30 is operated is described in detail below with reference to FIG. 2.

FIG. 2 is an operation diagram according to the first mode of a heat pump system for a vehicle according to an embodiment of the present disclosure.

Referring to FIG. 2, in the first mode, the refrigerant line 11 connecting the compressor 10, the condenser 12, the sub-heat-exchanger 13, the first expansion valve 14, and the evaporator 15 may be opened.

In an embodiment, the first line 32 may be opened by the third expansion valve 33. The second line 34 may be opened.

The third line 36 and the fourth line 37 may be closed by the fourth expansion valve 35.

In addition, the second connection line 41 may be closed by the control valve 42.

The third connection line 43, the fourth connection line 45, and the fifth connection line 46 may be closed by the fifth expansion valve 44. The operation of the fifth expansion valve 44 may be stopped.

In such a state, the refrigerant compressed in the compressor 10 may be introduced into the condenser 12 along or through the refrigerant line 11. The third coolant line 6 may be closed so that the coolant is not supplied to the heating device 7.

The condenser 12 may condense the refrigerant by using the coolant supplied from a radiator (not shown) and the electrical component 3.

The refrigerant having passed through the condenser 12 may pass through the fourth expansion valve 35 along or through the refrigerant line 11, to be introduced into the sub-heat-exchanger 13. The fourth expansion valve 35 may allow the refrigerant introduced from the condenser 12 to flow to the sub-heat-exchanger 13 without expansion.

Accordingly, the sub-heat-exchanger 13 may additionally condense the introduced refrigerant through heat-exchanging with the ambient air.

A partial refrigerant among the refrigerant discharged from the sub-heat-exchanger 13 may be introduced into the third expansion valve 33 along the first line 32.

The third expansion valve 33 may expand the refrigerant introduced through the first line 32, and supply the expanded refrigerant to the heat-exchanger 31 through the first line 32.

In addition, a remaining refrigerant among the refrigerant discharged from the sub-heat-exchanger 13 may be introduced into the heat-exchanger 31 along the refrigerant line 11.

Then, the heat-exchanger 31 may heat-exchange the refrigerant introduced through the refrigerant line 11 from the sub-heat-exchanger 13, and the refrigerant introduced from the third expansion valve 33 into the first line 32, with each other.

Accordingly, the heat-exchanger 31 may heat-exchange the refrigerant supplied from the third expansion valve 33, and the refrigerant supplied from the sub-heat-exchanger 13, with each other. Thereafter, the heat-exchanger 31 may supply the gaseous refrigerant among the heat-exchanged refrigerant to the compressor 10 through the second line 34.

Through such an operation, the gas injection device 30 may allow the gaseous refrigerant discharged from the heat-exchanger 31 to flow back to the compressor 10 through the second line 34, to increase the flow rate of the refrigerant circulating through the refrigerant line 11.

The refrigerant introduced into the heat-exchanger 31 from the sub-heat-exchanger 13 along the refrigerant line 11 may be additionally condensed through heat-exchanging with the refrigerant supplied through the first line 32.

The refrigerant additionally condensed in the heat-exchanger 31 may be introduced into the first expansion valve 14 along the refrigerant line 11.

The first expansion valve 14 may expand the refrigerant introduced through the refrigerant line 11 and supply the expanded refrigerant to the evaporator 15.

In such a state, the ambient air introduced into an HVAC module (not shown) may be cooled by the low-temperature refrigerant introduced into the evaporator 15 while passing through the evaporator 15. The cooled ambient air may cool the vehicle interior by being directly introduced into the vehicle interior.

In addition, the refrigerant having passed through the evaporator 15 may be introduced into the compressor 10 along the refrigerant line 11.

When cooling of the battery module 5 is required in the first mode, the first connection line 21 may be opened by the second expansion valve 23.

A partial refrigerant among the refrigerant having passed through the heat-exchanger 31 from the sub-heat-exchanger 13 may be introduced into the second expansion valve 23 along the first connection line 21.

In other words, the refrigerant discharged from the heat-exchanger 31 to the refrigerant line 11 may be introduced into the first expansion valve 14 and the second expansion valve 23 along the refrigerant line 11 and the first connection line 21, respectively.

The second expansion valve 23 may expand the refrigerant introduced through the first connection line 21 and supply the expanded refrigerant to the chiller 20.

The refrigerant introduced into the chiller 20 may cool the coolant while being heat-exchanged with the coolant supplied from the battery module 5 through the second coolant line 4.

The coolant cooled in the chiller 20 may be supplied to the battery module 5 along the second coolant line 4. Accordingly, the battery module 5 may be efficiently cooled by the coolant cooled in the chiller 20.

In other words, the coolant circulating through the second coolant line 4 may efficiently cool the battery module 5 while repeatedly performing the above-described operation.

The refrigerant having passed through the chiller 20 may be introduced into the compressor 10 together with the refrigerant discharged from the evaporator 15. The introduced refrigerant may be compressed by the compressor 10.

The refrigerant compressed in the compressor 10 may be supplied to the condenser 12 along the refrigerant line 11.

The heat pump system may repeatedly perform the above-described processes.

In other words, while repeatedly performing the above-described operation, the heat pump system may increase the flow rate of the refrigerant flowing along the refrigerant line 11.

In addition, the heat pump system may increase the flow rate of the refrigerant flowing along the refrigerant line 11, thereby improving the overall cooling performance and efficiency of the system, and efficiently cooling the vehicle interior.

When cooling of the battery module 5 is required in the first mode, the heat pump system may efficiently cool the battery module 5 by using a low-temperature coolant cooled in the chiller 20.

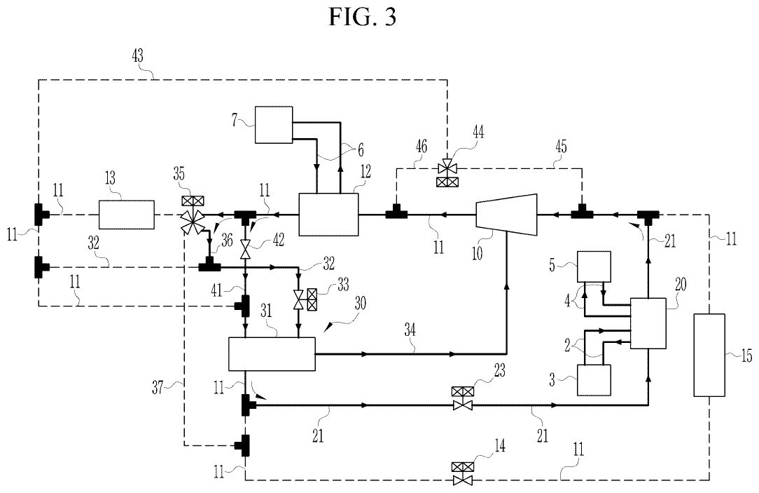

In an embodiment, an operation in the second mode of the heat pump system, which is for recollecting the waste heat of the electrical component 3 and the waste heat of the battery module 5 while heating the vehicle interior, and in which the gas injection device 30 is operated, is described in detail below with reference to FIG. 3.

FIG. 3 is an operation diagram according to the second mode of a heat pump system for a vehicle according to an embodiment of the present disclosure.

Referring to FIG. 3, in the second mode, a portion of the refrigerant line 11 interconnecting the compressor 10, the condenser 12, and the fourth expansion valve 35 may be opened by the fourth expansion valve 35.

In addition, the portion of the refrigerant line 11 connecting the first end of the first connection line 21 and the heat-exchanger 31, and the portion of the refrigerant line 11 connecting the second end of the first connection line 21 and the compressor 10, may be opened.

In addition, the portion of the refrigerant line 11 connecting a second end of the second connection line 21 and the heat-exchanger 31 may be opened.

In addition, the portion of the refrigerant line 11 connecting the first end of the first connection line 21 to the first expansion valve 14 and the evaporator 15, and the refrigerant line 11 connecting the evaporator 15 to the second end of the first connection line 21, may be closed.

In this example, operation of the first expansion valve 14 may be stopped. Accordingly, the refrigerant may not be supplied to the evaporator 15.

The first connection line 21 may be opened by the second expansion valve 23.

In an embodiment, a portion of the first line 32 connecting the first end of the first line 32 to the second end of the third line 36 may be closed.

A remaining portion of the first line 32 connecting the second end of the third line 36 to the heat-exchanger 31 may be opened by the third expansion valve 33.

The second line 34 may be opened. In addition, the third line 36 may be opened by the fourth expansion valve 35.

The second connection line 41 may be opened by the control valve 42. In addition, the third connection line 43, the fourth connection line 45, and the fifth connection line 46 may be closed by the fifth expansion valve 44.

In this example, the operation of the fifth expansion valve 44 may be stopped.

In such a state, the refrigerant compressed in the compressor 10 may be introduced into the condenser 12 along the refrigerant line 11. The third coolant line 6 may be opened so that coolant is the supplied to the heating device 7.

Accordingly, the refrigerant introduced into the condenser 12 may be condensed while being heat-exchanged with the coolant supplied from the heating device 7 through the third coolant line 6. The coolant whose temperature is increased through heat-exchange with the refrigerant in the condenser 12 may be supplied to the heating device 7.

A partial refrigerant among the refrigerant condensed in the condenser 12 may be introduced into the heat-exchanger 31 along the opened second connection line 41 and a portion of the refrigerant line 11.

In addition, a remaining refrigerant among the refrigerant condensed in the condenser 12 may be introduced into the fourth expansion valve 35 along the refrigerant line 11.

The fourth expansion valve 35 may allow the refrigerant introduced through the refrigerant line 11 to flow to the third line 36 without expansion.

In other words, the refrigerant flowing from the condenser 12 to the third line 36 may be introduced into the third expansion valve 33 along the opened portion of the first line 32.

The third expansion valve 33 may expand the refrigerant introduced through the first line 32, and may supply the expanded refrigerant to the heat-exchanger 31 through the opened portion of the first line 32.

Accordingly, the heat-exchanger 31 may heat-exchange the expanded refrigerant introduced through the first line 32, and the refrigerant supplied from the condenser 12, with each other. Thereafter, the heat-exchanger 31 may supply the gaseous refrigerant among the heat-exchanged refrigerant to the compressor 10 through the second line 34.

Through such an operation, the gas injection device 30 may allow the gaseous refrigerant discharged from the heat-exchanger 31 to flow back to the compressor 10 through the second line 34, to increase the flow rate of the refrigerant circulating the refrigerant line 11.

The refrigerant introduced from the condenser 12 into the heat-exchanger 31 may be additionally condensed through heat-exchange with the refrigerant supplied through the first line 32.

In addition, the refrigerant discharged from the heat-exchanger 31 to the refrigerant line 11 may be introduced into the second expansion valve 23 along the portion of the refrigerant line 11 and the first connection line 21.

The second expansion valve 23 may expand the refrigerant introduced through the first connection line 21 and supply the expanded refrigerant to the chiller 20.

The refrigerant introduced into the chiller 20 may be heat-exchanged with the coolant supplied from the electrical component 3 through the first coolant line 2. At the same time, the refrigerant introduced into the chiller 20 may be heat-exchanged with the coolant supplied from the battery module 5 through the second coolant line 4.

The coolant may have its temperature increased by recollecting the waste heat from the electrical component 3 and the waste heat from the battery module 5 while cooling the electrical component 3 and the battery module 5, respectively. Each coolant whose temperature is increased through such an operation may be supplied to the chiller 20.

The chiller 20 may recollect the waste heat of the electrical component 3 and the waste heat of the battery module 5 while heat-exchanging the respective coolant supplied from the electrical component 3 and the battery module 5 through the first coolant line 2 and second coolant line 4 with the refrigerant.

In addition, the refrigerant having passed through the chiller 20 may be introduced into the compressor 10 along the refrigerant connection line 21 and the opened first line 11.

In other words, the refrigerant having passed through the chiller 20 and the refrigerant supplied from the heat-exchanger 31 through the second line 34 may be introduced into the compressor 10. The introduced refrigerant may be compressed by the compressor 10.

The refrigerant compressed in the compressor 10 may be supplied to the condenser 12 along the refrigerant line 11. Thereafter, the heat pump system may repeatedly perform the above-described processes.

The ambient air introduced into the vehicle interior may be converted into a high-temperature state through heat-exchange with the high-temperature coolant introduced into the heating device 7 and introduced into the vehicle interior, thereby achieving heating of the vehicle interior.

Accordingly, the refrigerant circulating in the heat pump system can smoothly recollect the waste heat from each coolant whose temperature is increased while passing through the electrical component 3 and the battery module 5, in the chiller 20, thereby improving the overall heating performance and efficiency of the system.

In addition, according to an embodiment of the present disclosure, the heating efficiency and performance may be improved while minimizing the usage of a separate electric heater.

In other words, while repeatedly performing the above-described operation, the heat pump system of the present disclosure may increase the flow rate of the refrigerant flowing along the refrigerant line 11.

In addition, the gas injection device 30 can increase the flow rate of the refrigerant circulating the refrigerant line 11, thereby maximizing the heating performance of the system.

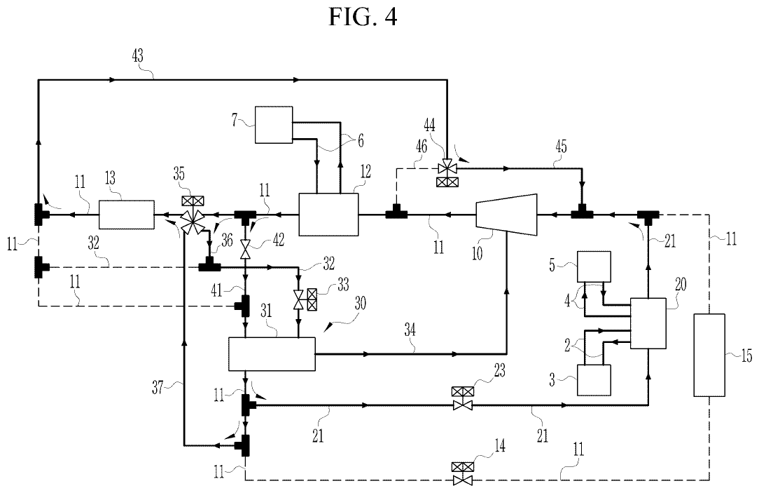

In an embodiment, an operation in the third mode for recollecting the ambient air heat, the waste heat of the electrical component 3, and the waste heat of the battery module 5 while heating the vehicle interior, and in which the gas injection device 30 may be operated is described in detail below with reference to FIG. 4.

FIG. 4 is an operation diagram according to the third mode of a heat pump system for a vehicle according to an embodiment of the present disclosure.

Referring to FIG. 4, in the third mode of the heat pump system, the portion of the refrigerant line 11 connecting the compressor 10, the condenser 12, and the fourth expansion valve 35 may be opened by the fourth expansion valve 35.

In addition, the portion of the refrigerant line 11 connecting the fourth expansion valve 35 to the first end of the third connection line 43 through the sub-heat-exchanger 13 may be opened by the fourth expansion valve 35 and the fifth expansion valve 44.

In addition, the portion of the refrigerant line 11 connecting the first end of the first connection line 21 and the heat-exchanger 31, and the portion of the refrigerant line 11 connecting the second end of the first connection line 21 and the compressor 10, may be opened.

In addition, the portion of the refrigerant line 11 connecting the second end of the second connection line 21 and the heat-exchanger 31 may be opened.

In addition, the portion of the refrigerant line 11 connecting the first end of the first connection line 21 to the second end of the fourth line 37 may be opened.

In addition, the portion of the refrigerant line 11 connecting the second end of the fourth line 37 to the first expansion valve 14 and the evaporator 15, and the refrigerant line 11 connecting the evaporator 15 to the second end of the first connection line 21, may be closed.

In this example, operation of the first expansion valve 14 may be stopped. Accordingly, the refrigerant may not be supplied to the evaporator 15.

The first connection line 21 may be opened by the second expansion valve 23.

In an embodiment, a portion of the first line 32 connecting the first end of the first line 32 to the second end of the third line 36 may be closed.

A remaining portion of the first line 32 connecting the second end of the third line 36 to the heat-exchanger 31 may be opened by the third expansion valve 33.

The second line 34 may be opened. In addition, the third line 36 and the fourth line 37 may be opened by the fourth expansion valve 35.

The second connection line 41 may be opened by the control valve 42.

In addition, the third connection line 43 and the fourth connection line 45 may be opened by the fifth expansion valve 44. In addition, the fifth connection line 46 may be closed by the fifth expansion valve 44.

In such a state, the refrigerant compressed in the compressor 10 may be introduced into the condenser 12 along the refrigerant line 11. The third coolant line 6 may be opened so that coolant is the supplied to the heating device 7.

Accordingly, the refrigerant introduced into the condenser 12 may be condensed while being heat-exchanged with the coolant supplied from the heating device 7 through the third coolant line 6. The coolant whose temperature is increased through heat-exchange with the refrigerant in the condenser 12 may be supplied to the heating device 7.

A partial refrigerant among the refrigerant condensed in the condenser 12 may be introduced into the heat-exchanger 31 along the opened second connection line 41 and the portion of the refrigerant line 11.

In addition, a remaining refrigerant among the refrigerant condensed in the condenser 12 may be introduced into the fourth expansion valve 35 along the refrigerant line 11.

The fourth expansion valve 35 may allow the refrigerant introduced through the refrigerant line 11 to flow to the third line 36 without expansion.

In other words, the refrigerant flows from the condenser 12 to the third line 36 and may be introduced into the third expansion valve 33 along the opened portion of the first line 32.

The third expansion valve 33 may expand the refrigerant introduced through the first line 32, and may supply the expanded refrigerant to the heat-exchanger 31 through the opened portion of the first line 32.

Accordingly, the heat-exchanger 31 may heat-exchange the expanded refrigerant introduced through the first line 32, and the refrigerant supplied from the condenser 12, with each other. Thereafter, the heat-exchanger 31 may supply the gaseous refrigerant among the heat-exchanged refrigerant to the compressor 10 through the second line 34.

Through such an operation, the gas injection device 30 may allow the gaseous refrigerant discharged from the heat-exchanger 31 to flow back to the compressor 10 through the second line 34, and to increase the flow rate of the refrigerant circulating through the refrigerant line 11.

The refrigerant introduced from the condenser 12 into the heat-exchanger 31 may be additionally condensed through heat-exchange with the refrigerant supplied through the first line 32.

In addition, a partial refrigerant among the refrigerant discharged from the heat-exchanger 31 to the refrigerant line 11 may be introduced into the second expansion valve 23 along the portion of the refrigerant line 11 and the first connection line 21.

The second expansion valve 23 may expand the refrigerant introduced through the first connection line 21 and supply the expanded refrigerant to the chiller 20.

The refrigerant introduced into the chiller 20 may be heat-exchanged with the coolant supplied from the electrical component 3 through the first coolant line 2. At the same time, the refrigerant introduced into the chiller 20 may be heat-exchanged with the coolant supplied from the battery module 5 through the second coolant line 4.

The coolant may have its temperature increased by recollecting the waste heat from the electrical component 3 and the waste heat from the battery module 5 while cooling the electrical component 3 and the battery module 5, respectively. Each coolant whose temperature is increased through such an operation may be supplied to the chiller 20.

The chiller 20 may recollect the waste heat of the electrical component 3 and the waste heat of the battery module 5 while heat-exchanging the respective coolant supplied from the electrical component 3 and the battery module 5 through the first coolant line 2 and the second coolant line 4 with the refrigerant.

A remaining refrigerant among the refrigerant discharged from the heat-exchanger 31 to the refrigerant line 11 may be introduced into the fourth expansion valve 35 along the fourth line 37.

The fourth expansion valve 35 may expand the refrigerant introduced through the fourth line 37, and supply the expanded refrigerant to the sub-heat-exchanger 13 through the refrigerant line 11.

The sub-heat-exchanger 13 may evaporate the refrigerant supplied from the fourth expansion valve 35 through heat-exchange with the ambient air. The refrigerant may directly absorb the ambient air heat from the ambient air.

The refrigerant having recollected the ambient air heat while passing through the sub-heat-exchanger 13 may be introduced into the fifth expansion valve 44 along a portion of the refrigerant line 11 and the third connection line 43.

The fifth expansion valve 44 may allow the refrigerant introduced through the third connection line 43 to flow to the fourth connection line 45 without expansion.

In addition, the refrigerant flowing along the fourth connection line 45 may be introduced into the compressor 10 along the opened refrigerant line 11 together with the refrigerant flowing from the chiller 20 along the first connection line 21.

In other words, the refrigerant having passed through the sub-heat-exchanger 13 and the chiller 20, respectively, and the refrigerant supplied from the heat-exchanger 31 through the second line 34 may be introduced together into the compressor 10. The introduced refrigerant may be compressed by the compressor 10.

The refrigerant compressed in the compressor 10 may be supplied to the condenser 12 along the refrigerant line 11. Thereafter, the heat pump system may repeatedly perform the above-described processes.

The ambient air introduced into the vehicle interior may be converted into a high-temperature state through heat-exchange with the high-temperature coolant introduced into the heating device 7 and introduced into the vehicle interior, thereby achieving heating of the vehicle interior.

Accordingly, the refrigerant circulating in the heat pump system may recollect the ambient air heat in the sub-heat-exchanger 13, and can smoothly recollect the waste heat from each coolant whose temperature is increased while passing through the electrical component 3 and the battery module 5, in the chiller 20, thereby improving the overall heating performance and efficiency of the system.

In addition, according to an embodiment of the present disclosure, the heating efficiency and performance of the system may be improved while minimizing the usage of a separate electric heater.

In other words, while repeatedly performing the above-described operation, the heat pump system may increase the flow rate of the refrigerant flowing along the refrigerant line 11.

In addition, the gas injection device 30 can increase the flow rate of the refrigerant circulating the refrigerant line 11, thereby maximizing the heating performance.

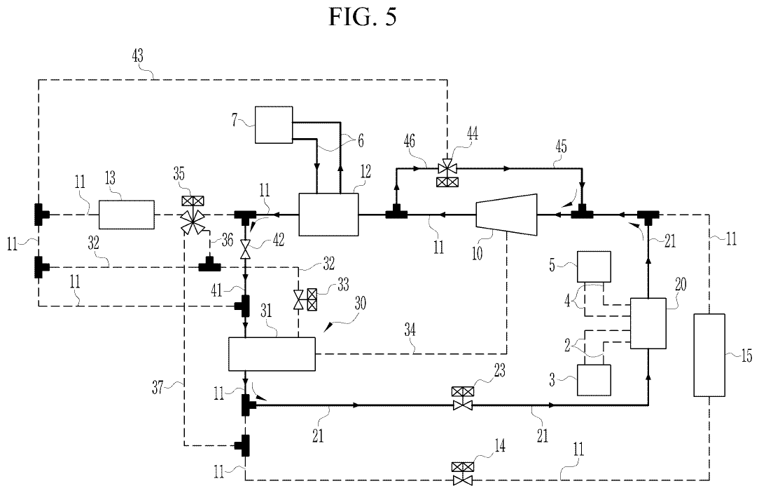

In addition, an operation in the fourth mode, which is for heating the vehicle interior by using the refrigerant without recollecting heat, and in which the gas injection device 30 is not operated, is described in detail below with reference to FIG. 5.

FIG. 5 is an operation diagram according to the fourth mode of a heat pump system for a vehicle according to an embodiment of the present disclosure.

Referring to FIG. 5, when the ambient air heat, the waste heat of the electrical component 3, and the waste heat of the battery module 5 is not sufficient, the heat pump system may not recollect enough heat from those sources.

In other words, when heating of the vehicle interior is required while the external temperature is low and the heat generated from the electrical component 3 and the battery module 5 is not sufficient in an early state of driving the vehicle, the heat pump system may perform heating of the vehicle interior by directly using the high-pressure and high-temperature refrigerant.

As such, heating the vehicle interior by using only the refrigerant may be referred to as a hot gas heating mode.

In an embodiment, in the fourth mode, the portion of the refrigerant line 11 connecting the compressor 10 to the first end of the second connection line 41 via the condenser 12 may be opened.

In addition, the portion of the refrigerant line 11 connecting the first end of the second connection line 41 to the second end of the second connection line 41 via the fourth expansion valve 35 and the sub-heat-exchanger 13 may be closed by the fourth expansion valve 35.

In addition, the portion of the refrigerant line 11 connecting the heat-exchanger 31 and the first end of the first connection line 21, and the portion of the refrigerant line 11 connecting the second end of the first connection line 21 and the compressor 10, may be opened.

In addition, the portion of the refrigerant line 11 connecting the first end of the first connection line 21 to the second end of the first connection line 21 through the first expansion valve 14 and the evaporator 15 may be closed by the first expansion valve 14.

In addition, the portion of the refrigerant line 11 connecting the second end of the second connection line 41 and the heat-exchanger 31 may be opened.

In this example, operation of the first expansion valve 14 may be stopped. Accordingly, the refrigerant may not be supplied to the evaporator 15.

The first connection line 21 may be opened by the second expansion valve 23.

In an embodiment, the first line 32 may be closed by the third expansion valve 33. The second line 34 may be closed.

The third line 36 and the fourth line 37 may be closed by the fourth expansion valve 35. The operation of the third expansion valve 33 and the fourth expansion valve 35 may be stopped.

In an embodiment, the second connection line 41 may be opened by the control valve 42.

In addition, the third connection line 43 may be closed by the fifth expansion valve 44. In addition, the fourth connection line 45 and the fifth connection line 46 may be opened by the fifth expansion valve 44.

In such a state, the refrigerant compressed in the compressor 10 may flow along the refrigerant line 11 connected to the condenser 12.

A partial refrigerant among the refrigerant discharged from the compressor 10 may be introduced into the fifth connection line 46 and then supplied to the fifth expansion valve 44.

The fifth expansion valve 44 may expand the refrigerant introduced through the fifth connection line 46 from the compressor 10. Thereafter, the fifth expansion valve 44 may allow the expanded refrigerant to flow along the fourth connection line 45.

A remaining refrigerant among the refrigerant discharged from the compressor 10 may be introduced into the condenser 12 along the refrigerant line 11. The third coolant line 6 may be opened so that coolant is supplied to the heating device 7.

Accordingly, the refrigerant introduced into the condenser 12 may be condensed while being heat-exchanged with the coolant supplied from the heating device 7 through the third coolant line 6. The coolant whose temperature is increased through heat-exchange with the refrigerant in the condenser 12 may be supplied to the heating device 7.

The refrigerant condensed in the condenser 12 may be introduced into the heat-exchanger 31 along the opened second connection line 41 and the portion of the refrigerant line 11.

The refrigerant having passed through the heat-exchanger 31 may be introduced into the second expansion valve 23 along the portion of the refrigerant line 11 and the first connection line 21.

The second expansion valve 23 may expand the refrigerant introduced through the first connection line 21 and supply the expanded refrigerant to the chiller 20. The first coolant line 2 and the second coolant line 4 may be closed so that the refrigerant and the coolant may not be heat-exchanged in the chiller 20.

In other words, since the heat generated from the electrical component 3 and the battery module 5 is not sufficient, the coolant may not be introduced into the chiller 20.

In addition, the refrigerant having passed through the chiller 20 may flow along the first connection line 21 and the opened portion of the refrigerant line 11.

In other words, the refrigerant expanded in the second expansion valve 23 and having passed through the chiller 20, and the refrigerant expanded in the fifth expansion valve 44 and flowing along the fourth connection line 45, may be introduced into the compressor 10.

The refrigerant introduced into the compressor 10 may be supplied again to the condenser 12 and the fifth expansion valve 44, respectively.

The ambient air introduced into the vehicle interior may be converted into a high-temperature state through heat-exchange with the high-temperature coolant introduced into the heating device 7 and introduced into the vehicle interior, thereby achieving heating of the vehicle interior.

In other words, in an embodiment, when the heat is not sufficient in the early stage of driving the vehicle in a state that the external temperature is low, while repeatedly performing the above-described operation, the vehicle interior may be heated by using the high-temperature refrigerant supplied from the compressor 10.

Therefore, as described above, according to a heat pump system for a vehicle according to an embodiment, cooling and heating performance may be improved by applying the gas injection device 30 selectively operating in an air conditioning mode of the vehicle interior to increase the flow rate of the refrigerant.

In addition, according to the present disclosure, the performance of the system by using the gas injection device 30 may be maximized while minimizing the required system components, and accordingly, streamlining and simplification of the system may be achieved.

In addition, according to the present disclosure, at the time of heating of the vehicle interior, the ambient air heat, the waste heat of the electrical component 3, or the waste heat of the battery module 5 may be selectively used, and thereby the heating efficiency may be improved.

In addition, according to the present disclosure, even when the external temperature is low and the heat generated from the electrical component 3 and the battery module 5 is not sufficient the in an early state of driving the vehicle, heating of the vehicle interior may be efficiently performed.

In addition, according to the present disclosure, through streamlining of an entire system, it is possible to reduce manufacturing cost and weight and improve space utilization of the system and the vehicle.

While this disclosure has been described in connection with what is presently considered to be practical embodiments, it is to be understood that the present disclosure is not limited to the disclosed embodiments. On the contrary, the present disclosure is intended to cover various modifications and equivalent arrangements included within the spirit and scope of the appended claims.

### DESCRIPTION OF SYMBOLS

2: first coolant line
3: electrical component
4: second coolant line
5: battery module
6: third coolant line
7: heating device
10: compressor
11: refrigerant line
12: condenser
13: sub-heat-exchanger
14: first expansion valve
15: evaporator
20: chiller
21: first connection line
23: second expansion valve
30: gas injection device
31: heat-exchanger
32: first line
33: third expansion valve
34: second line
35: fourth expansion valve
36: third line
37: fourth line
41: second connection line
42: control valve
43: third connection line
44: fifth expansion valve
45: fourth connection line
46: fifth connection line

What is claimed is:

1. A heat pump system for a vehicle, the heat pump system comprising:
a compressor configured to compress a refrigerant;
a condenser connected to the compressor through a refrigerant line, and configured to condense the refrigerant;
a first expansion valve connected to the condenser through the refrigerant line;
an evaporator connected to the first expansion valve through the refrigerant line, connected to the compressor through the refrigerant line, and configured to evaporate the refrigerant;
a first connection line having a first end connected to the refrigerant line between the condenser and the first expansion valve, and a second end connected to the refrigerant line between the compressor and the evaporator;
a chiller provided on the first connection line, and configured to adjust a temperature of a coolant by heat-exchanging the refrigerant introduced through the first connection line with the coolant;
a second expansion valve provided on the first connection line at an upstream end of the chiller;
a sub-heat-exchanger provided on the refrigerant line between the condenser and the first expansion valve, and configured to condense or evaporate selectively introduced refrigerant; and
a gas injection device provided on the refrigerant line between the sub-heat-exchanger and the first expansion valve, the gas injection device being configured to selectively expand the refrigerant supplied from one of the condenser or the sub-heat-exchanger and allow the refrigerant expanded by the gas injection device to flow, and selectively supply a partial refrigerant, among the refrigerant supplied to the gas injection device, to the compressor to increase a flow rate of the refrigerant circulating through the refrigerant line,
wherein, based on at least one mode of the heat pump system for adjusting a temperature of a vehicle interior, the flow rate of the refrigerant is controlled through an operation control of the gas injection device.

2. The heat pump system of claim 1, wherein the gas injection device comprises:
a heat-exchanger provided on the refrigerant line between the sub-heat-exchanger and the first expansion valve;
a first line having a first end connected to the refrigerant line between the sub-heat-exchanger and the heat-exchanger and a second end connected to the heat-exchanger;
a third expansion valve provided on the first line at an upstream end of the heat-exchanger;
a second line having a first end connected to the heat-exchanger and a second end connected to the compressor;
a fourth expansion valve provided on the refrigerant line between the condenser and the sub-heat-exchanger;
a third line having a first end connected to the fourth expansion valve and a second end connected to the first line; and
a fourth line having a first end connected to the fourth expansion valve and a second end connected to the refrigerant line between the heat-exchanger and the first expansion valve.

3. The heat pump system of claim 2, wherein the heat-exchanger is configured to be operated when the expanded refrigerant is supplied through the first line, and configured to supply a gaseous refrigerant, among the refrigerant supplied to the heat-exchanger, to the compressor through the second line to increase the flow rate of the refrigerant circulating through the refrigerant line.

4. The heat pump system of claim 2, wherein, when an operation of the gas injection device is required, the third expansion valve is configured to expand the refrigerant supplied from at least one of the condenser or the sub-heat-exchanger through the first line, and configured to supply the refrigerant expanded by the third expansion valve to the heat-exchanger.

5. The heat pump system of claim 2, further comprising:
a second connection line having a first end connected to the refrigerant line between the condenser and the fourth expansion valve and a second end connected to the refrigerant line between the sub-heat-exchanger and the heat-exchanger;
a control valve provided on the second connection line, and configured to selectively open and close the second connection line;
a third connection line having a first end connected to the refrigerant line between the sub-heat-exchanger and the heat-exchanger; and
a fifth expansion valve connected to a second end of the third connection line.

6. The heat pump system of claim 5, comprising:
a fourth connection line having a first end connected to the fifth expansion valve and a second end connected to the refrigerant line between the evaporator and the compressor; and
a fifth connection line having a first end connected to the refrigerant line between the compressor and the condenser and a second end connected to the fifth expansion valve.

7. The heat pump system of claim 6, wherein the at least one mode comprises:
a first mode for cooling the vehicle interior and in which the gas injection device is configured to be operated;
a second mode for recollecting a waste heat of an electrical component and a waste heat of a battery module while heating the vehicle interior and in which the gas injection device is configured to be operated;
a third mode for recollecting ambient air heat, the waste heat of the electrical component, and the waste heat of the battery module while heating the vehicle interior and in which the gas injection device is configured to be operated; and
a fourth mode for heating the vehicle interior by using the refrigerant without recollecting heat and in which the gas injection device is configured not to be operated.

8. The heat pump system of claim 7, wherein, in the first mode:
the refrigerant line connecting the compressor, the condenser, the sub-heat-exchanger, the first expansion valve, and the evaporator is configured to be opened;
the first line is configured to be opened by the third expansion valve;
the second line is configured to be opened;
the third line and the fourth line are configured to be closed by the fourth expansion valve;
the second connection line is configured to be closed by the control valve;
the third connection line, the fourth connection line, and the fifth connection line are configured to be closed by the fifth expansion valve;
the first expansion valve is configured to expand the refrigerant introduced through the refrigerant line and configured to supply the refrigerant expanded by the first expansion valve to the evaporator;
the third expansion valve is configured to expand the refrigerant introduced through the first line, and configured to supply the refrigerant expanded by the third expansion valve to the heat-exchanger through the first line;
the fourth expansion valve is configured to allow the refrigerant introduced from the condenser to flow to the sub-heat-exchanger without expansion;
the fifth expansion valve is configured to stop operating; and
the heat-exchanger is configured to supply a gaseous refrigerant among the refrigerant supplied to the heat-exchanger to the compressor through the opened second line.

9. The heat pump system of claim 8, wherein, when cooling of the battery module is required in the first mode:
the first connection line is configured to be opened by the second expansion valve; and
the second expansion valve is configured to expand the refrigerant introduced through the first connection line and configured to supply the refrigerant expanded by the second expansion valve to the chiller.

10. The heat pump system of claim 7, wherein, in the second mode:
a portion of the refrigerant line connecting the compressor, the condenser, and the fourth expansion valve is configured to be opened by the fourth expansion valve;
a portion of the refrigerant line connecting the first end of the first connection line and the heat-exchanger and a portion of the refrigerant line connecting the second end of the first connection line and the compressor is configured to be opened;
a portion of the refrigerant line connecting the second end of the second connection line and the heat-exchanger is configured to be opened;
a portion of the refrigerant line connecting the first end of the first connection line to the first expansion valve and the evaporator, and the refrigerant line connecting the evaporator to the second end of the first connection line, are configured to be closed;
the first connection line is configured to be opened by the second expansion valve;
a portion of the first line connecting the first end of the first line to the second end of the third line is configured to be closed;
a remaining portion of the first line connecting the second end of the third line to the heat-exchanger is configured to be opened by the third expansion valve;
the second line is configured to be opened;
the third line is configured to be opened by the fourth expansion valve;
the second connection line is configured to be opened by the control valve;
the third connection line, the fourth connection line, and the fifth connection line are configured to be closed by the fifth expansion valve;
the first expansion valve and the fifth expansion valve are configured to stop operating;
the second expansion valve is configured to expand the refrigerant introduced through the first connection line and configured to supply the refrigerant expanded by the second expansion valve to the chiller;
the third expansion valve is configured to expand the refrigerant introduced through the first line, and configured to supply the refrigerant expanded by the third expansion valve to the heat-exchanger through the first line;
the fourth expansion valve is configured to allow the refrigerant introduced through the refrigerant line to flow to the third line without expansion; and
the heat-exchanger is configured to supply the gaseous refrigerant among the refrigerant supplied to the heat-exchanger to the compressor through the opened second line.

11. The heat pump system of claim 7, wherein, in the third mode:
a portion of the refrigerant line connecting the compressor, the condenser, and the fourth expansion valve is configured to be opened by the fourth expansion valve;
a portion of the refrigerant line connecting the fourth expansion valve to the first end of the third connection line is configured to be opened by the fourth expansion valve and the fifth expansion valve;
a portion of the refrigerant line connecting the first end of the first connection line and the heat-exchanger and a portion of the refrigerant line connecting the second end of the first connection line and the compressor is configured to be opened;
a portion of the refrigerant line connecting the second end of the second connection line and the heat-exchanger is configured to be opened;
a portion of the refrigerant line connecting the first end of the first connection line to the second end of the fourth line is configured to be opened;
a portion of the refrigerant line connecting the second end of the fourth line to the first expansion valve and the evaporator, and the refrigerant line connecting the evaporator to the second end of the first connection line, are configured to be closed;
the first connection line is configured to be opened by the second expansion valve;
a portion of the first line connecting the first end of the first line to the second end of the third line is configured to be closed;
a remaining portion of the first line connecting the second end of the third line to the heat-exchanger is configured to be opened by the third expansion valve;
the second line is configured to be opened;
the third line is configured to be opened by the fourth expansion valve;
the fourth line is configured to be opened by the fourth expansion valve;
the second connection line is configured to be opened by the control valve;
the third connection line and the fourth connection line are configured to be opened by the fifth expansion valve;
the fifth connection line is configured to be closed by the fifth expansion valve;
the first expansion valve is configured to stop operating;
the second expansion valve is configured to expand the refrigerant introduced through the first connection line and configured to supply the refrigerant expanded by the second expansion valve to the chiller;
the third expansion valve is configured to expand the refrigerant introduced through the first line, and configured to supply the refrigerant expanded by the third expansion valve to the heat-exchanger through the first line;
the fourth expansion valve is configured to allow the refrigerant introduced from the condenser to flow to the fourth expansion valve in the third line without expansion;
the fourth expansion valve is configured to expand the refrigerant introduced through the fourth line, and configured to supply the refrigerant expanded by the fourth expansion valve to the sub-heat-exchanger through the refrigerant line;
the fifth expansion valve is configured to allow the refrigerant introduced through the third connection line to flow to the fourth connection line without expansion; and
the heat-exchanger is configured to supply the gaseous refrigerant among the refrigerant supplied to the heat-exchanger to the compressor through the opened second line.

12. The heat pump system of claim 7, wherein, in the fourth mode:
a portion of the refrigerant line connecting the compressor to the first end of the second connection line through the condenser is configured to be opened;
a portion of the refrigerant line connecting the first end of the second connection line to the second end of the second connection line through the fourth expansion valve and the sub-heat-exchanger is configured to be closed by the fourth expansion valve;
a portion of the refrigerant line connecting the heat-exchanger and the first end of the first connection line, and a portion of the refrigerant line connecting the second end of the first connection line and the compressor, are configured to be opened;
a portion of the refrigerant line connecting the first end of the first connection line to the second end of the first connection line through the first expansion valve and the evaporator is configured to be closed by the first expansion valve;
a portion of the refrigerant line connecting the second end of the second connection line and the heat-exchanger is configured to be opened;
the first connection line is configured to be opened by the second expansion valve;
the first line is configured to be closed by the third expansion valve;
the second line is configured to be closed;
the third line and the fourth line are configured to be closed by the fourth expansion valve;
the second connection line is configured to be opened by the control valve;
the third connection line is configured to be closed by the fifth expansion valve;
the fourth connection line and the fifth connection line are configured to be opened by the fifth expansion valve;
the first expansion valve, the third expansion valve, and the fourth expansion valve are configured to stop operating;
the second expansion valve is configured to expand the refrigerant introduced through the first connection line and configured to supply the refrigerant expanded by the second expansion valve to the chiller; and
the fifth expansion valve is configured to expand the refrigerant introduced through the fifth connection line from the compressor, and configured to allow the refrigerant expanded by the fifth expansion valve to flow along the fourth connection line.

13. The heat pump system of claim 5, wherein the fifth expansion valve is a 3-way electronic expansion valve configured to selectively expand the refrigerant while controlling the flow of the refrigerant supplied thereto.

14. The heat pump system of claim 2, wherein:
the first expansion valve, the second expansion valve, and the third expansion valve are 2-way electronic expansion valves configured to selectively expand the refrigerant while controlling a flow rate of the refrigerant supplied thereto; and
the fourth expansion valve is a 4-way electronic expansion valve configured to selectively expand the refrigerant while controlling the flow rate of the refrigerant supplied thereto.

15. The heat pump system of claim 1, further comprising:
an electrical component and a battery module in which the coolant circulates; and
a heating device in which the coolant circulates to heat the vehicle interior by using a high-temperature coolant.

16. The heat pump system of claim 15, wherein the chiller is connected to the electrical component through a first coolant line circulating the coolant, and connected to the battery module through a second coolant line circulating the coolant.

17. The heat pump system of claim 16, wherein, when a waste heat of the electrical component is to be recollected at a time of heating the vehicle interior, the first coolant line is configured to be opened to connect the chiller and the electrical component.

18. The heat pump system of claim 16, wherein, when the battery module is to be cooled while cooling the vehicle interior, or when a waste heat of the battery module is to be recollected at a time of heating the vehicle interior, the second coolant line is configured to be opened to connect the chiller and the battery module.

19. The heat pump system of claim 15, wherein the condenser is connected to the heating device through a third coolant line circulating the coolant.

20. The heat pump system of claim 19, wherein, when heating the vehicle interior, the third coolant line is configured to be opened to connect the condenser and the heating device.
